(19) United States
(12) Patent Application Publication
(10) Pub. No.: US 2002/0154989 A1
(43) Pub. Date: Oct. 24, 2002

(54) Covered propeller

(76) Inventors: Matthias Brunig, Hamburg (DE); Herbert D. Stolle, Hamburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/110,984

(22) PCT Filed: Aug. 16, 2001
(86) PCT No.: PCT/EP01/09418

(30) Foreign Application Priority Data
Aug. 21, 2000 (DE) 100 40 837.0

(51) Int. Cl. F03D 7/00

(52) U.S. Cl. 415/2.1

(57) ABSTRACT

The invention relates to a covered propeller for conveying gases and liquids, for operating land, air and water vehicles and operating in a reverse mode as a water or wind generator. Conveyor blades (21, 24) are disposed around a rotational axis in a helical manner. Two successive conveyor blades are respectively connected to a covering element (22, 33) in a peripheral direction. The covering element is twisted in a longitudinal direction and is disposed between the radially external outflow end (31, 34) of one of the blade conveyors and the radially internal area of the hub area, of the following blade conveyor.

The invention relates to a covered propeller for conveying gases and liquids and for operating land, air and water vehicles, consisting of at least two leaf-shaped conveyor blades disposed around a rotational axis in a helical manner, of which two successive conveyor blades respectively are connected with a covering element.

The propeller can be used as wind generator or as water turbine in the reverse mode.

In a known covered propeller (DE OS 36 38 060), the covering element is arranged such that it extends between mutually adjacent conveyor blades in the radially outer area of the covered propeller almost in parallel to the rotational axis.

The known covered propeller has been applicable in many cases, mainly as propeller for air acceleration and also with high rates of revolutions due to technical reasons. However, an increase of the rate of revolutions is limited by the former arrangement of the cover. For on the one hand, the cover extending almost in parallel to the propeller axis is loaded during high rates of revolutions by centrifugal forces regarding bending such that it may break.

Furthermore, the respective cover is pressure loaded by the deviation of the associated outer outflow edge of the respective following conveyor blade, which causes an additional risk of bending. In order to avoid these risks without reducing the desired slope of the outflow edges, the cover reduced to the belt of about ⅛ of the radius of a conveyor blade does not engage at the outflow edge of the following conveyor blade according to the invention, but in the inner hub area by about the width of the cover above the hole for the propeller shaft. Furthermore, the cover is twisted in its longitudinal direction preferably by about 45° such that it has a larger slope in the vicinity of the hub regarding the medium flowing in than at the outflow edge to the preceding conveyor blade.

By the first provision, the cover lies at about 45° regarding the propeller shaft and the bending forces caused by the centrifugal force are reduced to ˜0.7 of the forces according to the known covered propeller (DE OS 36 38 060). Furthermore, the outflow edge of the following conveyor blade is not interfered with regarding flow like before, which implies a reduction of noise as well. Above that, a saving of material results therefrom. By the turned up formation at the joint of the engine shaft, the moments of flexure are absorbed there such that a hub used in ordinary propellers is not required. By the second provision, the bending risk is reduced, since the angular impulse regarding the plane belt is enlarged in the centre at the point of the largest flexure during bending. Furthermore, this arrangement contributes to the conveying performance. With these two arrangements the propeller achieves high rates of revolution without risk of breakage. As will be shown below, a large slope of the outflow ends of the conveyor blades is desired for many applications. According to the invention, the conveyor blades in the inner part are therefore buckled out at the outflow line to a slope larger than at the outer edge such that the space between the cover and the outflow line of the following conveyor blade is enlarged. Thereby, a vortex train is formed in the outflow area of the medium, which flows in a desired manner opposed to the spin of the medium flowing off. When used as a generator, the medium is forced outwards thereby, which improves the degree of efficiency. As during propeller operation the outflow velocity is up to five times of the inflow velocity, the exit cross-section of the propellers can be reduced to up to ⅕ of the inflow cross-section. This reduction of cross-section can also be achieved by mounting of the engine in the outflow direction with suitable encasing or guide surface. If in this arrangement blowing is effected against a wall as a second baffle, the propeller operates additionally as radial propeller due to the spin of the medium flowing off, and the flow form indicated below results. Further features of the invention arise from the subordinated claims.

The invention will be explained below by way of example with reference to the drawing.

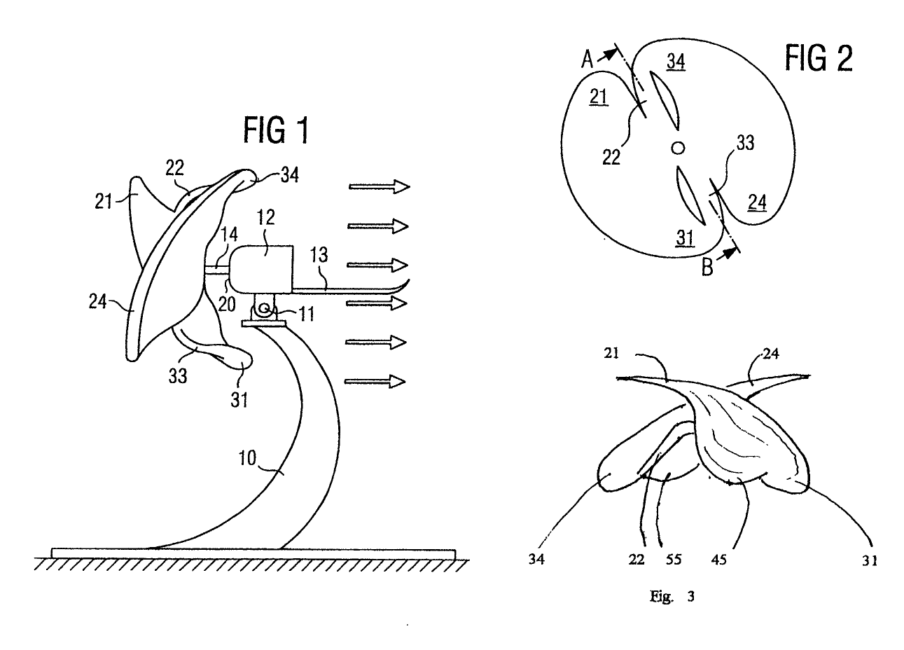

FIG. 1 shows a graphical view of a covered propeller according to the invention.

FIG. 2 shows a plan view onto the propeller.

FIG. 3 shows a side view transversely to the line AB of FIG. 2.

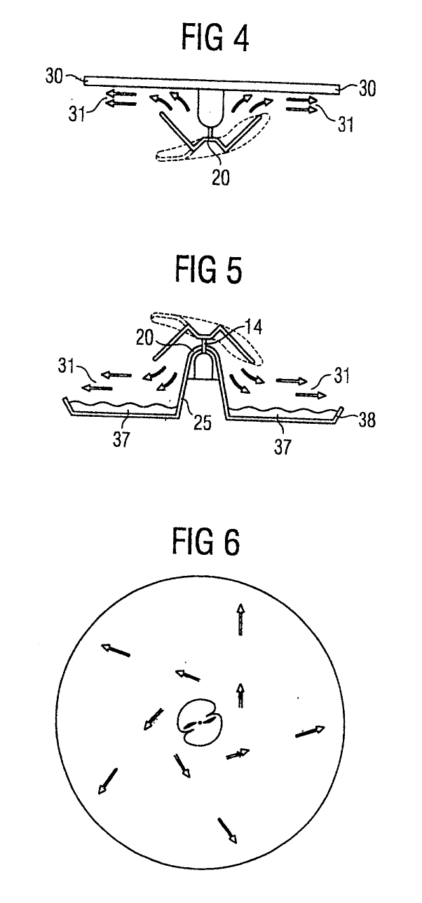

FIG. 4 shows the propeller in section AB according to FIG. 2.

FIG. 5 shows an additional encasing of the engine in section AB according to FIG. 2.

FIG. 6 shows a plan view during impact flow.

In FIG. 1, a support leg is indicated by 10, on the top area of which an engine 12 rests. 11 schematically indicates a connection possibility between the engine 12 and the locally fixed leg 10, wherein the engine 12 can be brought to the desired position by means of a rod-shaped handle 13. The engine 12 can be rotated around a vertical axis. The engine 12 can further be rotated out of the shown position around a horizontal axis up to about 45° downwards and up to 45° upwards.

A shaft 14 projects from the engine housing 12, on which the covered propeller according to the invention is mounted. The covered propeller consists for example of two conveyor blades 21 and 24, the shape of which will be explained in more detail below. The conveyor blades respectively extend across 180° in the peripheral direction in case of a covered propeller with two conveyor blades. The conveyor blades 21 and 24 consist of uniformly thin leaf-like material, preferably made of plastic with a thickness extension of several mm. The conveyor blades 21 and 24 have been deformed in the axial direction as well as in the radial direction and comprise an inflow side and an outflow end, respectively. The inflow side can be seen on the left hand side in the figure, the outflow side on the right hand side, and the six arrows indicated there illustrate the direction of the produced flow.

The conveyor blade 21 includes an outflow end 31 and the conveyor blade 24 comprises an outflow end 34 according to FIGS. 1 and 2. The cover 22 projects radially from the inner part of the conveyor blade 21 and ends at the outflow end 34 of the conveyor blade 24, while the cover 33 extends from the inner part of the conveyor blade 24 to the end 31 of the conveyor blade 21.

Each cover is twisted in the longitudinal direction such that a larger slope exists in the hub area regarding the medium flowing out than at the outflow end of the preceding conveyor blade.

The two conveyor blades 21 and 24 are connected with each other without hub and sit on the shaft 14. In the radially internal area, the flow according to a preferred embodiment of the invention reaches a deflector surface 20, which is the front wall on the left side of the engine 12 (FIG. 1).

According to the invention, the shape of the conveyor blades is determined in that the conveyed medium obtains a possibly uniform acceleration when passing through the propeller.

With a constant rate of revolution v, the propeller has reached the angle a=v after the time t and the conveyed portion must have continued its flow in the propeller by the distance y =a/2 t². Since y is proportional to t², y must also be proportional to a². Therefore, the conveyor surface must have the distance y from the inflow point in flow direction at the angle a. Or: the propeller area must lie at an angle a after y in the flow direction. That means a parabola on the cylinder surface of the cylinder section with the propeller of the same axis. However, due to the continuity condition a portion does not flow exactly on a cylinder surface through the propeller.

As the propeller has an outflow velocity of four to five times compared to the inflow, the outflow cross-section is advantageously reduced by this factor compared to the inflow cross-section, as indicated above. It is understood that this condition complies with the mounting of the driving engine 12 on the outflow side. This additionally provides the possibility to attach a position handle 13 at the engine 12 or at the housing thereof, which enables a simple handling for upward and downward as well as sideward displacement with respective support of the engine 12 on the support leg 10.

A special feature of the covered propeller advantageous for many applications are the bulges 45, 55 according to FIG. 3. The slope of the outflow line inside of the conveyor blades 21 and 24 is enlarged thereby. A vortex train is formed during the propeller operation thereby, which is opposed to the total spin of the medium flowing out. In reverse operation as generator, the medium flowing in is forced outwards by these bulges, which results in a better torque and degree of efficiency.

The covered propeller proposed according to the invention must comprise the flatly arranged cover and the large slope of the outflow edge, in order to achieve advantages not possible so far with two baffle or guide surfaces according to FIGS. 4 and 5: the first baffle or guide surface, the front surface of the possibly encased engine 20, provides for the cross-section reduction in the acceleration within the propeller, while a radial wall flow is formed on the second surface 20. A radial component also operates for this wall flow in the propeller due the slope of the conveyor blades. More specifically: the spin energy of the propeller flow merges into the wall flow such that a flow diagram according to FIG. 6 is formed, wherein the arrows illustrate the wall flow found experimentally. Especially, an arrangement according to FIG. 4 with an impact jet directed upwards under a table plate can provide good cooling for the persons sitting around the table. Of course, the engine can also be covered by a cylindrical or conical encasing 25 according to FIG. 5, the drive shaft 14 being passed through the baffle surface 20 thereof. The encasing can be fixedly connected with a tray 38 filled with water 37 for the dust separation. Thus an engine without additional water protection can incorporated. An inflow passing obliquely to the baffle surface can also advantageously be used to spread the stream fanwise. Advantages arise from the arrangement according to the FIGS. 4 and 5 due to the flow according to FIG. 6, when heating rods or heating coils are circularly arranged around the propeller on the baffle plate, as the air stream extends obliquely through the heating coils then, resulting in higher heat absorption, since the air stream is longer in contact with the heating element than in case of an air stream passing transversely to the heating coil.

In reverse mode, the propeller can be used for example as wind generator, as it starts at low wind velocities already and has a high degree of efficiency in this operation.

1. Covered propeller for conveying gases and liquids for operating land, air and water vehicles and in reverse mode as wind generator, comprising at least two leaf-shaped conveyor blades disposed around a rotational axis in a helical manner, wherein two conveyor blades successive in the peripheral direction are respectively connected to a covering element, characterised in that the covering element (22, 33) connects the radially outer outflow ends (34, 31) of the conveyor blades (21, 24) with the radially inner area, the hub area, of the respective conveyor blade following in the peripheral extension, and that the covering elements (22, 33) are formed belt-like and are twisted in their longitudinal direction such that the slope in relation to the medium flowing in inside, in the hub area, is larger than in the outflow area at the outflow ends (34, 31).

2. Covered propeller according to claim 1, characterised in that a deflecting or baffle surface (20, 5) is mounted in the outflow area.

3. Covered propeller according to claim 2, characterised in that the deflecting or baffle surface (20) is formed by the side of the engine (12) housing facing the propeller.

4. Covered propeller according to one of the claims 1 to 3, characterised in that the covering elements extend at about 45° regarding the axis.

5. Covered propeller according to one of the claims 1 to 4, characterised in that the conveyor blades in their radially internal area sit on the driving shaft (14) of the engine (12) without hub.

6. Covered propeller according to one of the claims 1 to 5 as impact jet propeller, characterised in that a first guide or baffle surface constricting the acceleration zone in the propeller and a second baffle surface exist, onto which the propeller stream acts axially and/or radially.

7. Covered propeller according to one of the claims 1 to 6, characterised in that the covering elements (22, 33) are twisted in a longitudinal direction by about 1 /8 of a turn (about 45°).

8. Covered propeller according to one of the claims 1 to 7, characterised in that the outflow edge in the inner area of the conveyor blades is respectively bulged, enlarging the space between cover and previous conveyor blade.
